(19) United States
(12) Patent Application Publication
(10) Pub. No.: US 2008/0024480 A1
(43) Pub. Date: Jan. 31, 2008

(54) DISPLAY DEVICE AND METHOD OF DRIVING THE SAME

(76) Inventors: Ahn-Ho Jee, Hwaseong-si (KR); Dong-Hwan Lee, Yongin-si (KR); Chul-Hwan Lee, Yongin-si (KR); Young-Man Kim, Seongnam-si (KR)

Correspondence Address: F. CHAU & ASSOCIATES, LLC, 130 WOODBURY ROAD, WOODBURY, NY, 11797, US

(21) Appl. No.: 11/766,149

(22) Filed: Jun. 21, 2007

(30) Foreign Application Priority Data
Jul. 28, 2006 (KR) 2006-71292

(51) Int. Cl. G06F 3/038

(52) U.S. Cl. 345/212

(57) ABSTRACT

A display panel includes a light-providing unit, a display panel and a panel driving unit. The display panel selectively displays an image corresponding to a first driving mode and a second driving mode using light from the light-providing unit. The panel driving unit includes a power supply, a data driver and a gate controller. The power supply includes a first power supply and a second power supply selectively outputting a first power voltage and a second power voltage corresponding to the first driving mode and the second driving mode. The second power voltage is smaller than the first power voltage. The data driver and the gate controller respectively output a data voltage and a gate controlling signal to the display panel corresponding to the driving mode.

### CROSS-REFERENCE TO RELATED PATENT APPLICATION

This application claims priority to Korean Patent Application No. 2006-71292, filed on Jul. 28, 2006 the contents of which are incorporated herein by reference in their entirety.

### BACKGROUND OF THE INVENTION

1. Technical Field

The present disclosure relates to a display device and a method of driving the display device. More particularly, the present disclosure relates to a display device capable of reducing power consumption and a method of driving the display device.

2. Discussion of Related Art

Various electronic devices such as mobile devices, digital cameras, notebook computers, monitors, and television sets include a display device to display an image. A flat panel display device is commonly used for the display device. For example, a liquid crystal display (LCD) device is a type of flat panel display device that is widely employed.

An LCD device displays an image by operating a liquid crystal panel. LCD devices are widely used for various applications, primarily due to their thin profile, low driving voltage, low power consumption, etc.

To improve optical characteristics and reduce power consumption of a mobile LCD device, a display panel may include a main display section and a sub display section. For example, the sub display section may show system status information such as time, date, signal strength and battery level.

A driving mode of the display panel may include a first driving mode to simultaneously drive the main display section and the sub display section, and a in second driving mode to drive only the sub display section. In the second driving mode, a panel driving unit driving the display panel may receive a driving voltage which is substantially the same as the driving voltage in the first driving mode. Therefore, in existing devices, the power consumption of the display panel may be increased in the second driving mode.

### SUMMARY OF THE INVENTION

According to an exemplary embodiment of the present invention, a display device includes a light-providing unit, a display panel and a panel driving unit. The display panel displays an image corresponding to a first driving mode or a second driving mode by using light from the light-providing unit.

The panel driving unit includes a power supply, a data driver and a gate controller.

The power supply includes a first power supply outputting a first power voltage corresponding to the first driving mode and a second power supply outputting a second power voltage corresponding to the second driving mode. The level of the second power voltage is smaller than the level of the first power voltage. The data driver outputs a first data voltage to the display panel in response to the first power voltage, and a second data voltage to the display panel in response to the second power voltage. The gate controller driver outputs a first gate controlling signal to the display panel in response to the first power voltage, and a second gate controlling signal to the display panel in in response to the second power voltage.

The display panel may include a plurality of display lines, wherein the display panel displays the image through a first set of the display lines in a first driving mode, wherein the display panel displays the image through a second set of display lines in a second driving mode, and wherein the second set of display lines is a subset of the first set of display lines.

A level of the second data voltage may be smaller than a level of the first data voltage.

The display panel may comprise a gate driver respectively outputting a first gate voltage to the display panel in response to the first gate controlling signal, and a second gate voltage, which may be smaller than the first gate voltage, to the display panel in response to the second gate controlling signal. The gate driver may include an amorphous silicon gate (ASG) formed on an edge portion of the display panel.

The first power supply and the second power supply may be separately formed.

The power supply may further include a mode selector outputting a mode selecting signal to the first power supply and the second power supply in response to a mode controlling signal. The mode selecting signal may include a first mode selecting signal corresponding to the first driving mode and a second mode selecting signal corresponding to the second driving mode. The mode selector may include a multiplexer (MUX) circuit, wherein the MUX circuit switches the mode controlling signal and outputs the first mode selecting signal and the second mode selecting signal to the first power supply and the second power supply.

The panel driving unit may further include an input interface receiving the mode controlling signal from an external device. The external device may output the mode controlling signal to the panel driving unit through a serial peripheral interface (SPI) communication.

According to an exemplary embodiment of the present invention, a display device includes a light-providing unit, a display panel and a panel driving unit. The display panel displays an image corresponding to a first driving mode or a second driving mode by using light from the light-providing unit.

The panel driving unit drives the display panel and includes a power controller, a D/A converter, a data driver and a gate controller.

The power controller respectively outputs a first power controlling signal of a digital format, which corresponds to the first driving mode and a second power controlling signal of a digital format, which corresponds to the second driving mode. The D/A converter outputs a first power voltage of an analog format in response to the first power controlling signal, and a second power voltage of an analog format in response to the second power controlling signal, wherein a level of the second power voltage is smaller than a level of the first power voltage. The data driver outputs a first data voltage to the display panel in response to the first power voltage, and a second data voltage to the display panel in response to the second power voltage. The gate controller driver outputs a first gate controlling signal to the display panel in response to the first it power voltages and a second gate controlling signal to the display panel in response to the second power voltage.

According to an exemplary embodiment of the present invention, a method of driving a display device includes a display panel including a plurality of gate lines and a plurality of data lines. A panel driving unit receives a mode controlling signal. A mode selector selectively outputs, in response to the mode controlling signal, a first mode selecting signal to a first power supply corresponding to a first driving mode and a second mode selecting mode to a second power supply corresponding to a second driving mode. The first power supply outputs a first power voltage to a data driver and a gate controller in response to the first mode selecting signal, and the second power supply outputs a second power voltage to the data driver and the gate controller in response to the second mode selecting signal, wherein a level of the second power voltage is smaller than a level of the first power voltage. A data driver outputs a first data voltage to the display panel in response to the first power voltage, and a second data voltage to the display panel in response to the second power voltage. A gate controller selectively outputs a first gate controlling signal to the display panel in response to the first power voltage, and a second gate controlling signal to the display panel in response to the second power voltage.

The first power supply outputting the first power voltage and the second power supply outputting the second power voltage may be separately formed. The display panel selectively displays an image through a first set of display lines in the first driving mode, and displays the image through a second set of display in lines in the second driving mode, wherein the second set of display lines is a subset of the first set of display lines.

According to an exemplary method of driving a display device according to the present invention, the display device includes a display panel including a plurality of gate lines and a plurality of data lines, A panel driving unit receives a mode controlling signal, A mode selector selectively outputs, in response to the mode controlling signal, a first mode selecting signal corresponding to a first driving mode and a second mode selecting mode corresponding to a second driving mode to a power controller. The power controller selectively outputs a first power controlling signal of a digital format to a D/A converter in response to the first mode selecting signal, and a second power controlling signal of a digital format to a D/A converter in response to the second mode selecting signal. The D/A converter selectively outputs a first power voltage of an analog format, in response to the first power controlling signal, and a second power voltage of an analog format, in response to the second power controlling signal, to a data driver and a gate controller. The level of the second power voltage is smaller than the level of the first power voltage. The data driver selectively outputs a first data voltage to the display panel in response to the first power voltage and a second data voltage to the display panel in response to the second power voltage. The gate controller selectively outputs a first gate controlling signal to the display panel in response to the first power voltage and a second gate controlling signal to the display panel in response to the second power voltage.

The display panel may selectively display an image through a first set of in display lines in the first driving mode, and display the image through a second set of display lines in the second driving mode, wherein the second set of display lines is a subset of the first set of display lines.

### BRIEF DESCRIPTION OF THE DRAWINGS

The present invention will become more apparent to those of ordinary skill in the art when descriptions of exemplary embodiments thereof are read with reference to the accompanying drawings.

FIG. 1 is a block diagram illustrating a display device in accordance with an exemplary embodiment of the present invention.

FIG. 2 is a block diagram illustrating a panel driving unit of FIG. 1 according to an exemplary embodiment of the present invention.

FIG. 3 is a block diagram illustrating a power supply of FIG. 2 according to an exemplary embodiment of the present invention.

FIG. 4 is a block diagram illustrating a panel driving unit in accordance with an exemplary embodiment of the present invention.

FIG. 5 is a flow chart illustrating a method of driving a display device in accordance with an exemplary embodiment of the present invention.

FIG. 6 is a flow chart illustrating a method of driving a display device in accordance with an exemplary embodiment of the present invention.

### DESCRIPTION OF EXEMPLARY EMBODIMENTS

Hereinafter, exemplary embodiments of the present invention will be in described in detail with reference to the accompanying drawings. Like reference numerals refer to similar or identical elements throughout the description of the figures.

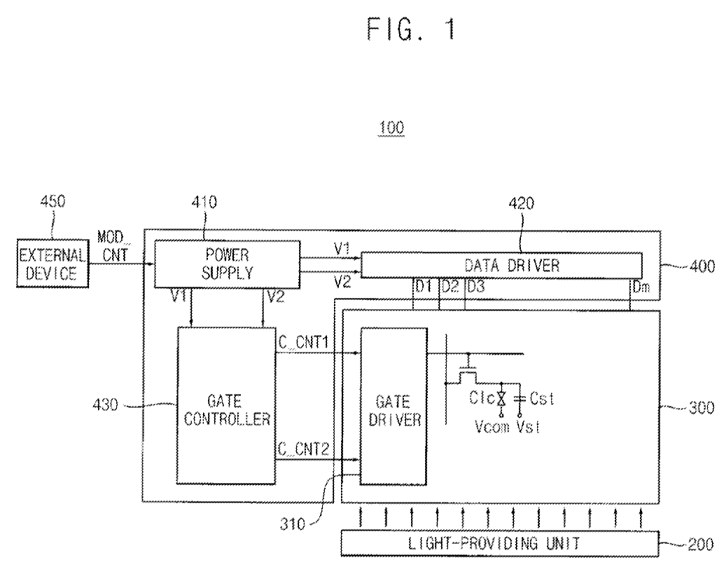

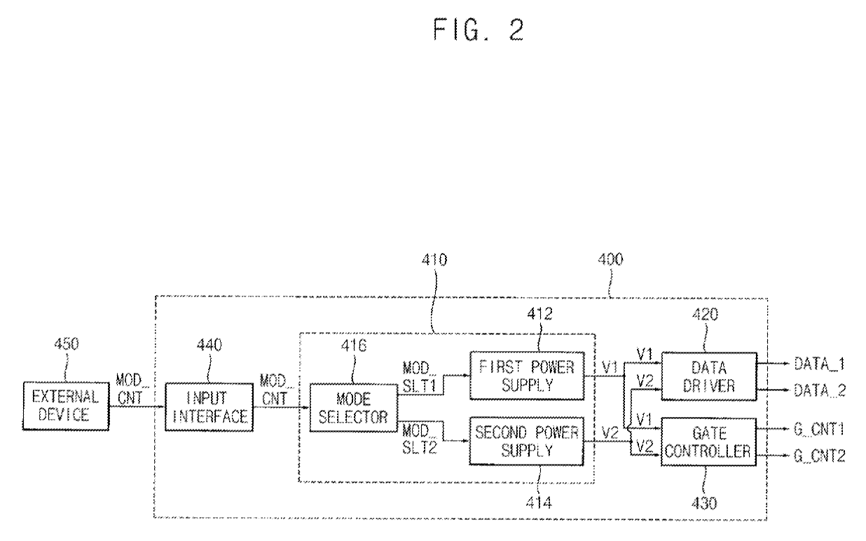

FIG. 1 is a block diagram illustrating a display device 100 in accordance with an exemplary embodiment of the present invention. FIG. 2 is a block diagram illustrating a panel driving unit 400 of FIG. 1, according to an exemplary embodiment of the present invention.

Referring to FIGS. 1 and 2, the display device 100 includes a light-providing unit 200, a display panel 300 and a panel driving unit 400.

The light-providing unit 200 provides a light having a predetermined luminance level to drive the display panel 300. The light-providing unit 200 may include a plurality of light-emitting diodes. A cold cathode fluorescent lamp (CCFL) may be employed as the light-providing unit 200.

The display panel 300 displays an image using light provided by the light-providing unit 200. The display panel 300 may include a plurality of display lines. When the display panel 300 displays an image through a whole set of display lines, the driving mode may be defined as a first driving mode. When the display panel 300 displays the image through a subset of the display lines, the driving mode may be defined as a second driving mode. In an exemplary embodiment of the present invention, the display panel 300 is selectively driven corresponding to the first driving mode or the second driving mode.

The display panel 300 may display main images, such as images and in text information using light in the first driving mode. The display panel 300 may display sub images, such as time, date and battery status, using light in the second driving mode.

The display panel 300 may be selectively driven corresponding to the first driving mode or the second driving mode, and power consumption of the display device 100 may be reduced. In the second driving mode, the display panel 300 may display images through a subset of the display lines, and the power consumption of the display device 100 may be reduced.

Referring to FIG. 2, the display panel 300 includes a plurality of gate lines and a gate driver 310 outputting a gate voltage to the gate lines. For example, the gate driver 310 may include an amorphous silicon gate (ASG) formed on an edge portion of the display panel 300. The gate driver 310 may be formed in the panel driving unit 400.

The panel driving unit 400 may include a power supply 410, a data driver 420 and a gate controller 430.

The power supply 410 may include a first power supply 412 and a second power supply 414. In an exemplary embodiment of the present invention, the first power supply 412 outputs a first power voltage V1 to the data driver 420 and the gate controller 430 in the first driving mode, and the second power supply 414 outputs a second power voltage V2 to the data driver 420 and the gate controller 430 in the second driving mode. The level of the second power voltage V2 may be smaller than the level of the first power voltage V1.

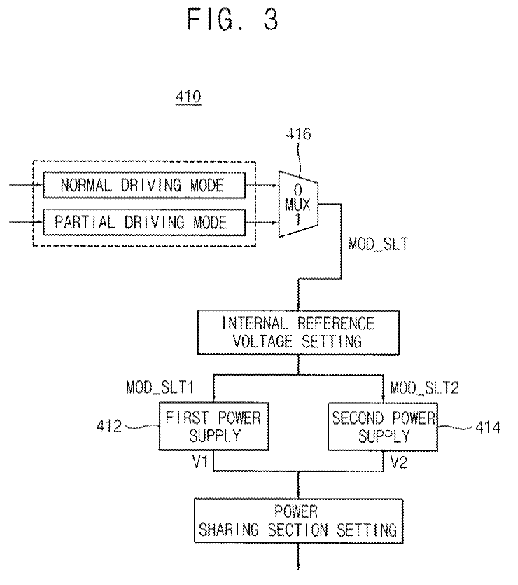

The power supply 410 may include a mode selector 416. The mode selector 416 may output a mode selecting signal MOD_SLT to the first power supply 412 and the second power supply 414 in response to a mode controlling signal MOD_CNT for example, from an external device 450. The mode selecting signal MOD_SLT may include a first mode selecting signal MOD_SLT1 corresponding to the first driving mode and a second mode selecting signal MOD_SLT2 corresponding to the second driving mode. The power supply 410 will be described later in this disclosure with reference to FIG. 3.

The panel driving unit 400 may include an input interface 440. The input interface 440 may receive the mode controlling signal MOD_CNT from the external device 450. The external device 450 may output the mode controlling signal MOD_CNT through a serial peripheral interface (SPI) communication.

The data driver 420 may respectively output a first data voltage DATA_1 corresponding to the first power voltage V1, and a second data voltage DATA_2 corresponding to the second power voltage V2. The level of the second data voltage DATA_2 may be smaller than the level of the first data voltage DATA_1.

The gate controller 430 may respectively output a first gate controlling signal G_CNT1 corresponding to the first power voltage V1, and a second gate controlling signal G_CNT2 corresponding to the second power voltage V2. The gate driver 310 of the display panel 300 may output a first gate voltage GATE_1 in response to the first gate controlling signal G_CNT1, and a second gate in voltage GATE_2 in response to the second gate controlling signal G_CNT2 to the display panel 300. The level of the first gate voltage GATE_1 may be smaller than the level of the second gate voltage GATE_2.

In the second driving mode, the display panel 300 may display the image in response to the second data voltage DATA_2 and the second gate voltage GATE_2, which may be smaller than the level of the first data voltage DATA_1 and the first gate voltage GATE_1.

In the first driving mode, the data voltage may be about 4.2 V, the gate-on voltage may be about 16V and the gate-off voltage may be about −9.87 V. In the second driving mode, the data voltage may be about 3.8 V, the gate-on voltage may be about 12.54V and the gate-off voltage may be about −7.4 V when the different data voltage and the gate voltage are output corresponding to the driving mode, the power consumption may be, for example, about 8 mW in the first driving mode, and the power consumption may be, for example, about 4.5 mW in the second driving mode. The display panel 300 displays a sub image using a driving voltage having a relatively small potential-level, and the power consumption may be reduced.

FIG. 3 is a block diagram illustrating a power supply 410 of FIG. 2, according to exemplary embodiments of the present invention.

Referring to FIGS. 2 and 3, the power supply 410 includes the first power supply 412, the second power supply 414 and the mode selector 416.

The mode selector 416 may output the mode selecting signal MOD_SLT in response to the mode controlling signal MOD_CNT from the external device in 450. In an exemplary embodiment of the present invention, the mode selector 416 switches the mode controlling signal MOD_CNT, and outputs the first mode selecting signal MOD_SLT1 and the second mode selecting signal MOD_SLT2 to the first power supply 412 and the second power supply 414, respectively. The first mode selecting signal MOD_SLT1 may correspond to the first driving mode, and the second mode selecting signal MOD_SLT2 may correspond to the second driving mode.

For example, the mode selector 416 may include a multiplexer (MUX) circuit 416 switching the mode controlling signal MOD_CNT. The MUX circuit 416 may receive a first mode controlling signal MOD_CNT1 corresponding to the first driving mode, and a second mode controlling signal MOD_CNT2 corresponding to the second driving mode. The MUX circuit 416 may switch the first mode controlling signal MOD_CNT1 and the second mode controlling signal MOD_CNT2, and may output the first mode selecting signal MOD_SLT1 or the second mode selecting signal MOD_SLT2 to the first power supply 412 or the second power supply 414.

A selection of the first driving mode or the second driving mode may be determined by hardware and/or software of the external device 450. The panel driving unit 400 may include the input interface 440. The input interface 440 may receive the mode controlling signal MOD_CNT from the external device 450. The panel driving unit 400 may include a separate device to select a driving mode.

For example, the first power supply 412 may be integrally formed with the second power supply 414 to form the power supply 410. The first and second power supplies 412 and 414 may be separately formed in the power supply 410 using different masks. The first power supply 412 and the second power supply 414 may be separately formed by changing the structure of the conventional power supply 410. The power supply 410 may be separately formed in the manufacture stage. For example, the first power supply 412 and the second power supply 414 may be formed at the exterior of the power supply 410 or formed in the panel driving unit 400. The first power supply 412 and the second power supply 414 may be formed with separate components.

In an exemplary embodiment of the present invention, the first power supply 412 outputs a first power voltage V1 to the data driver 420 and the gate controller 430 in the first driving mode, and the second power supply 414 outputs a second power voltage V2 to the data driver 420 and the gate controller 430 in the second driving mode. The level of the second power voltage V2 may be smaller than the level of the first power voltage V1.

For example, in the first driving mode, the first power supply 412 outputs the first power voltage V1 having a predetermined level to the data driver 420 and the gate controller 430. The display panel 300 may display images through a whole set of the display lines in response to the first power voltage V1. In the second driving mode, the second power supply 414 may output the second power voltage V2, which may have a smaller electric potential level than that of the first power voltage V1, to the data driver 420 and the gate controller 430. The display panel 300 may display images through a subset of the display lines in response to the second power voltage V2. In the second driving mode, the display panel 300 may be driven responding to the second power voltage V2 which may have a smaller electric potential level than that of the first power voltage V1, and the power consumption may be reduced.

Referring to FIG. 3, although the first power supply 412 and the second power supply 414 of the power supply 410 may be separated, a portion of the power supply 410 may be shared. For example, when the first power supply 412 and the second power supply 414 include resistor streams, the rest of the power supply 410 except for the resistor streams may be substantially the same as the conventional power supply. For example, the power supply 410 except for the first and second power supplies 412 and 414 may be shared to reduce volume, components and/or cost.

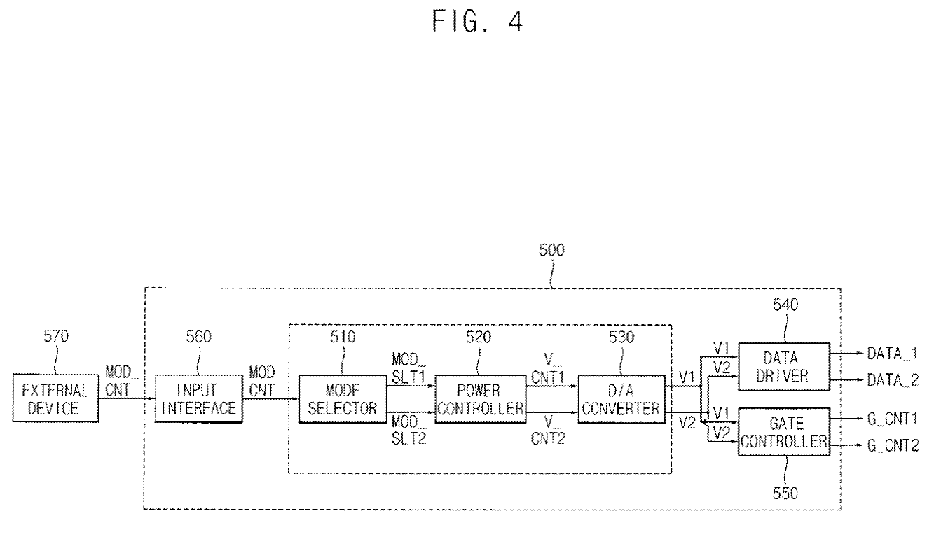

FIG. 4 is a block diagram illustrating a panel driving unit in accordance with an exemplary embodiment of the present invention. The display device of FIG. 4 is substantially the same as the display device shown in FIGS. 1, 2 and 3 except for the panel driving unit. Like reference numerals will be used to denote similar or identical elements and further description thereof will be omitted in the interests of clarity.

Referring to FIGS. 1 and 4, the panel driving unit 500 includes a mode selector 510, a power controller 520, a D/A converter 530, a data driver 540 and a gate controller 550.

The mode selector 510 may output a mode selecting signal MOD_SLT to the power controller 520 in response to a mode controlling signal MOD_CNT from an external device 570. For example the mode selector 510 may include a multiplexer (MUX) circuit to switch the mode controlling signal MOD_CNT. The mode selector 510 may output a first mode selecting signal MOD_SLT1 corresponding to the first driving mode and a second mode selecting signal MOD_SLT2 corresponding to the second driving mode.

The power controller 520 may output a first power controlling signal V_CNT1 of a digital format and a second power controlling signal V_CNT2 of a digital format to the D/A converter 530. The first power controlling signal V_CNT1 may correspond to the first driving mode and the second power controlling signal V_CNT2 may correspond to the second driving mode.

The power controller 520 corresponding to the power supply 410 may be integrally formed in the panel driving unit 500. In an exemplary embodiment of the present invention, the power controller 520 receives the mode selecting signal MOD_SLT and outputs the first power controlling signal V_CNT1 or the second power controlling signal V_CNT2 to the D/A converter 530.

The first power controlling signal V_CNT1 and the second power controlling signal V_CNT may have a digital-format.

The D/A converter 530 converts the first power controlling signal V_CNT1 into a first power voltage V1 of an analog format, and the second power controlling signal V_CNT2 into a second power voltage V2 of an analog format. The level of the second power voltage V2 may be smaller than the level of the first power voltage V1.

In an exemplary embodiment of the present invention, the D/A converter 530 receives the first power controlling signal V_CNT1 and the second power controlling signal V_CNT2, and respectively outputs the first power voltage V1 and the second power voltage V2 to the data driver 540 and the gate controller 550. The first power voltage V1 and the second power voltage V2 may be predetermined corresponding to the first power controlling signal V_CNT1 and the second power controlling signal V_CNT2. For example, the D/A converter 530 may read the first power controlling signal V_CNT1 of a digital format and the second power controlling signal V_CNT2 of a digital format into a predetermined value. The D/A converter 530 may output the predetermined value, which is the first power voltage V1 of an analog format and the second power voltage V2 of an analog format, to the data driver 540 and the gate controller 550. The D/A converter 530 may include a comparator (not shown). The comparator may compare the first and second power contorting signals V_CNT1 and V_CNT2 with the predetermined value. For example, the comparator may include an operational-amplifier (OP-AMP) to compare the first and second power controlling signals V_CNT1 and V_CNT2 with the predetermined value. The comparator may include a multiplexer (MUX) circuit to switch the first power controlling signal V_CNT1 and the second power controlling signal V_CNT2.

The data driver 540 may output a first power voltage DATA_1 and a second power voltage DATA_2 to the display panel 300 in response to the first in power voltage V1 and the second power voltage V2. The level of the second power voltage DATA_2 may be smaller than the level of the first power voltage V1. In an exemplary embodiment of the present invention, the display panel 300 displays the images using a portion of the display lines, and the power voltage and power consumption may be reduced.

The gate controller 550 may output a first gate controlling signal G_CNT1 and a second gate controlling signal G_CNT2 to the gate driver 310 in response to the first power voltage V1 and the second power voltage V2. The gate driver 310 of the display panel 300 outputs a first gate voltage GATE_1 corresponding to the first gate controlling signal G_CNT1, and a second gate voltage GATE_2 corresponding to the second gate controlling signal G_CNT2 to the display panel 300. The level of the first gate voltage GATE_1 may be smaller than the level of the second gate voltage GATE_2.

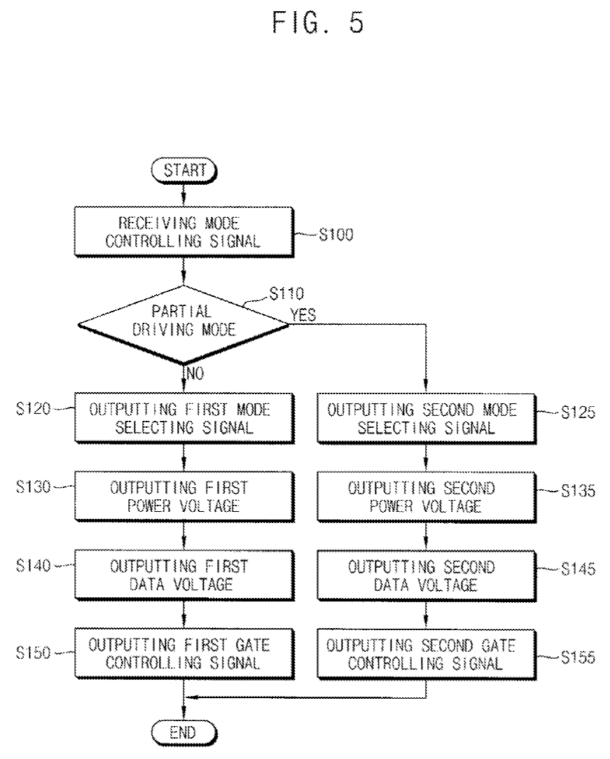

FIG. 5 is a flow chart illustrating a method of driving a display device in accordance with an exemplary embodiment of the present invention.

Referring to FIGS. 1, 2 and 5, according to a method of driving the display device 100, the panel driving unit 400 receives the mode controlling signal MOD_CNT from the external device 450, in step S100, and determines the driving mode of the display panel 300 in response to the mode controlling signal MOD_CNT in step S10.

When the driving mode is the first driving mode, the mode selector 416 outputs the first mode selecting signal MOD_SLT1, corresponding to the first driving mode, to the first power supply 412, in step S120. The first power supply 412 outputs the first power voltage V1 to the data driver 420 and the gate controller 430 in response to the first mode selecting signal MOD_SLT1, in step S130. The data driver 420 outputs the first data voltage DATA_1 to the display panel 300 in response to the first power voltage V1, in step S140. The gate controller 430 outputs the first gate controlling signal G_CNT1 to the display panel 300 in response to the first power voltage V1, in step S150.

When the driving mode is the second driving modes the mode selector 416 outputs the second mode selecting signal MOD_SLT2 corresponding to the second driving mode, to the second power supply 414, in step S125. The second power supply 414 outputs the second power voltage V2, which may be smaller than the level of the first power voltage V1, to the data driver 420 and the gate controller 430 in response to the second mode selecting signal MOD_SLT2, in step S135. The data driver 420 outputs the second data voltage DATA_2 to the display panel 300 in response to the second power voltage V2, in step S145. The gate controller 430 outputs the second gate controlling signal G_CNT2 to the display panel 300 in response to the second power voltage V2, in step S155.

In step S100, the panel driving unit 400 receives the mode controlling signal MOD_CNT from the external device 450. The panel driving unit 400 may include the input interface 440 to receive the mode controlling signal MOD_CNT from the external device 450.

In step S110, the mode selector 416 determines the driving mode of the display panel 300 in response to the mode controlling signal MOD_CNT. The in first driving mode or the second driving mode may be determined by the software of the external device 450. The panel driving unit 400 selects the driving mode of the display panel 300 in response to the mode controlling signal MOD_CNT input through the input interface 440. The driving mode of the display panel 300 may be precisely determined by the predetermined software of the external device 450.

In step S120, when the driving mode of the display panel 300 is the first driving mode, the mode selector 416 outputs the first mode selecting signal MOD_SLT1, corresponding to the first driving mode, to the first power supply 412. For examples, the mode selector 416 may include the multiplexer (MUX) circuit switching the mode controlling signal MOD_CNT. In an exemplary embodiment of the present invention, the mode selector 416 switches the input mode controlling signal MOD_CNT; selects the first mode controlling signal MOD_CNT1 corresponding to the first driving mode and outputs the first mode selecting signal MOD_SLT1 to the first power supply 412.

In step S130, the power supply 410 outputs the first power voltage V1 to the data driver 420 and the gate controller 430 in response to the first mode selecting signal MOD_SLT1. For example, the first power supply 412 of the power supply 410 outputs the first power voltage V1 to the data driver 420 and the gate controller 430 corresponding to the first driving mode.

In step S140, the data driver 420 outputs the first data voltage DATA_1 to the display panel 300 in response to the first power voltage V1. For example, in the data driver 420 outputs the first data voltage DATA_1, which has the predetermined value, to the data lines of the display panel 300 corresponding to the first driving mode.

In step S150, the gate controller 430 outputs the first gate controlling signal G_CNT1 to the gate driver 310 in response to the first power voltage V1. For example, the gate controller 430 outputs the first gate controlling signal G_CNT1 to the gate driver 310 corresponding to the first driving mode. The gate driver 310 of the display panel 300 outputs the first gate voltage GATE_1 to the display panel 300.

In step S125, when the driving mode of the display panel 300 is the second driving mode, the mode selector 416 outputs the second mode selecting signal MOD_SLT2, corresponding to the second driving mode, to the second power supply 414. For example, the mode selector 416 may include the multiplexer (MUX) circuit switching the mode controlling signal MOD_CNT. In an exemplary embodiment of the present invention, the mode selector 416 switches the input mode controlling signal MOD_CNT selects the second mode controlling signal MOD_CNT2 corresponding to the second driving mode and outputs the second mode selecting signal MOD_SLT2 to the second power supply 414.

In step S135, the power supply 410 outputs the second power voltage V2 to the data driver 420 and the gate controller 430 in response to the second mode selecting signal MOD_SLT2. For example, the second power supply 414 of the power supply 410 outputs the second power voltage V2 to the data driver 420 and the gate controller 430 corresponding to the second driving mode.

In step S145, the data driver 420 outputs the second data voltage DATA_2 to the display panel 300 in response to the second power voltage V2. For example, the data driver 420 outputs the second data voltage DATA_2 to the data lines of the display panel 300 corresponding to the second driving mode. Then, the level of the second data voltage DATA_2 may be smaller than the level of the first data voltage DATA_1.

In step S155, the gate controller 430 outputs the second gate controlling signal G_CNT2 to the gate driver 310 in response to the second power voltage V2. For example, the gate controller 430 outputs the second gate controlling signal G_CNT2 to the gate driver 310 corresponding to the second driving mode. The gate driver 310 of the display panel 300 outputs the second gate voltage GATE_2 to the display panel 300. The level of the second gate voltage GATE_2 may be smaller than the level of the first gate voltage GATE_1.

When the display device 100 is driven by the second data voltage DATA_2, which may be smaller than the level of the first data voltage DATA_1 in the second driving mode, the whole power consumption may be reduced.

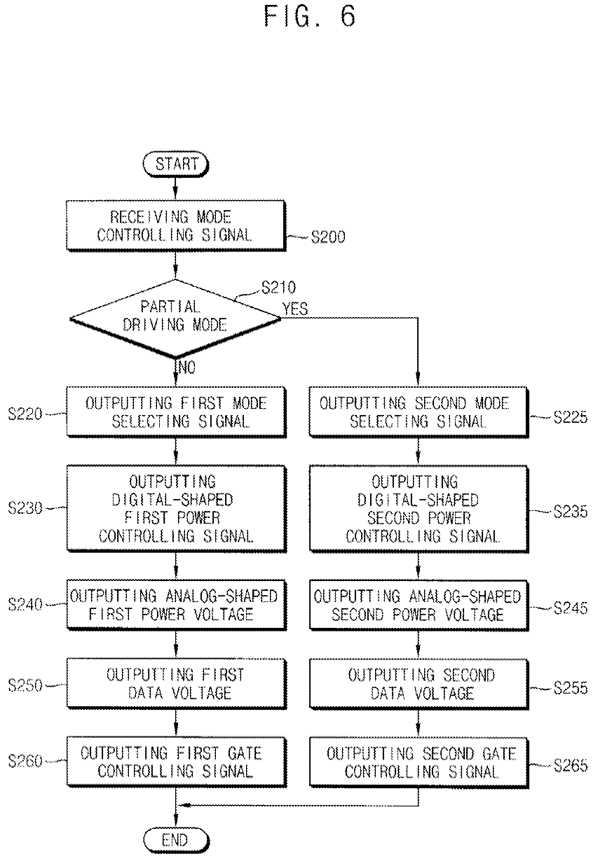

FIG. 6 is a flow chart illustrating a method of driving a display device in accordance with an exemplary embodiment of the present invention.

Referring to FIGS. 1, 4 and 6, according to a method of driving the display device 100, the panel driving unit 400 receives the mode controlling signal MOD_CNT from the external device 450, in step S200, and determines the driving mode of the display panel 300 in response to the mode controlling signal MOD_CNT in step S210.

When the driving mode is the first driving mode, the mode selector 510 outputs the first mode selecting signal MOD_SLT1 to the power controller 520, in step S220, corresponding to the first driving mode. The power controller 520 outputs the first power controlling signal V_CNT1 of a digital format to the D/A converter 530 in response to the first mode selecting signal MOD_SLT1, in step S230. The D/A converter 530 outputs the first power voltage V1 of an analog format to the data driver 540 and the gate controller 550 in response to the first power controlling signal V_CNT1, in step S240. The data driver 540 outputs the first data voltage DATA_1 to the display panel 300 in response to the first power voltage V1, in step S250. The gate controller 550 outputs the first gate controlling signal G_CNT1 to the display panel 300 in response to the first power voltage V1, in step S260.

When the driving mode is the second driving mode the mode selector 510 outputs the second mode selecting signal MOD_SLT2 to the power controller 520, in step S225 corresponding to the second driving mode. The power controller 520 outputs the second power controlling signal V_CNT2 of a digital format to the D/A converter 530 in response to the second mode selecting signal MOD_SLT2, in step S235. The D/A converter 530 outputs the second power voltage V2 of an analog format, which may be smaller than the level of the first power voltage V1, to the data driver 540 and the gate controller 550 in response to the second power controlling signal V_CNT2, in step S245. The data driver in 540 outputs the second data voltage DATA_2 to the display panel 300 in response to the second power voltage V2, in step S255. The gate controller 550 outputs the second gate controlling signal G_CNT2 to the display panel 300 in response to the second power voltage V2, in step S265.

A method of driving the display device in accordance with an exemplary embodiment of the present invention is substantially the same as the method of driving the display device in accordance with an exemplary embodiment of the present invention described in connection with FIGS. 1, 4 and 6, except for step S230, step S235, step S240 and step S245, and further description thereof will be omitted in the interests of clarity.

In step S230, the power controller 520 outputs the first power controlling signal V_CNT1 of a digital format to the D/A converter 530 in response to the first mode selecting signal MOD_SLT1. For example, the power controller 520 outputs the first power controlling signal V_CNT1 of a digital format to the D/A converter 530 corresponding to the first driving mode.

In step S240, D/A converter 530 outputs the first power voltage V1 of an analog format to the data driver 540 and the gate controller 550 in response to the first power controlling signal V_CNT1. For example, D/A converter 530 outputs the first power voltage V1 of an analog format, which may have a predetermined value, in response to the first power controlling signal V_CNT1 of a digital format. The D/A converter 530 may include the comparator (not shown) to compare the first power controlling signal V_CNT1 with the predetermined value.

In step S235, the power controller 520 outputs the second power controlling signal V_CNT2 of a digital format to the D/A converter 530 in response to the second mode selecting signal MOD_SLT2. For example, the power controller 520 outputs the second power controlling signal V_CNT2 of a digital format to the D/A converter 530 corresponding to the second driving mode.

In step S245, D/A converter 530 outputs the second power voltage V2 of an analog format to the data driver 540 and the gate controller 550 in response to the second power controlling signal V_CNT2. The level of the second power voltage V2 may be smaller than the level of the first power voltage V1. In an exemplary embodiment of the present invention, the D/A converter 530 outputs the second power voltage V2 of an analog format, which may have a predetermined value, in response to the second power controlling signal V_CNT2 of a digital format. The D/A converter 530 may include the comparator (not shown) to compare the second power controlling signal V_CNT1 with the predetermined value.

The display panel 300 may display imagery using a portion of the display lines corresponding to the second driving mode, and the output power voltage may be reduced and the power consumption of the display device 100 may be reduced.

According to an exemplary embodiment of the present inventions the power supply of the panel driving unit is separately formed corresponding to the driving mode. For example, when the display panel displays images through a in subset of the display lines in the second driving mode, the second power supply outputs the second power voltage, which may be smaller than the first power voltage output from the first power supply, to the data driver and the gate controller. Thus, the power voltage may be reduced in the second driving mode, and the power consumption may be reduced.

In an exemplary embodiment of the present invention, the power controller and the D/A converter adjust the power voltage which is output corresponding to the driving mode, and the power consumption may be reduced in the second driving mode.

Although exemplary embodiments of the present invention have been described in detail with reference to the accompanying drawings for the purpose of illustration, it is to be understood that the inventive processes and apparatus should not be construed as limited thereby. It will be apparent to those of ordinary skill in the art that various modifications to the foregoing exemplary embodiments can be made without departing from the scope of the invention as defined by the appended claims, with equivalents of the claims to be included therein,

What is claimed is:

1. A display device comprising:
a light-providing unit generating light;
a display panel selectively displaying an image corresponding to a first driving mode or a second driving mode using the light from the light-providing unit; and
a panel driving unit driving the display panel, the panel driving unit comprising:
in a power supply including a first power supply outputting a first power voltage corresponding to the first driving mode and a second power supply outputting a second power voltage corresponding to the second driving mode, wherein a level of the second power voltage is smaller than a level of the first power voltage;
a data driver outputting a first data voltage to the display panel in response to the first power voltage, and a second data voltage to the display panel in response to the second power voltage; and
a gate controller driver outputting a first gate controlling signal to the display panel in response to the first power voltage, and a second gate controlling signal to the display panel in response to the second power voltage.

2. The display device of claim 1, wherein the display panel comprises a plurality of display lines, wherein the display panel displays the image through a first set of display lines in the first driving mode, wherein the display panel displays the image through a second set of display lines in the second driving mode, and wherein the second set of display lines is a subset of the first set of display lines.

3. The display device of claim 1, wherein a level of the second data voltage is smaller than a level of the first data voltage.

4. The display device of claim 1, wherein the display panel comprises in a gate driver respectively outputting a first gate voltage to the display panel in response to the first gate controlling signal and a second gate voltage that is smaller than the first gate voltage to the display panel in response to the second gate controlling signal.

5. The display device of claim 4, wherein the gate driver comprises an amorphous silicon gate (ASG) formed on an edge portion of the display panel.

6. The display device of claim 1, wherein the first power supply and the second power supply are separately formed.

7. The display device of claim 2, wherein the power supply further comprises a mode selector outputting a mode selecting signal to the first power supply and the second power supply in response to a mode controlling signal.

8. The display device of claim 7, wherein the mode selecting signal comprises a first mode selecting signal corresponding to the first driving mode and a second mode selecting signal corresponding to the second driving mode.

9. The display device of claim 8, wherein the mode selector comprises a multiplexer (MUX) circuit that switches the mode controlling signal and outputs the first mode selecting signal to the first power supply and the second mode selecting signal to the second power supply.

10. The display device of claim 9, wherein the panel driving unit further comprises an input interface receiving the mode controlling signal from an external device.

11. The display device of claim 10, wherein the external device outputs the mode controlling signal to the panel driving unit through a serial peripheral interface (SPI) communication.

12. A display device comprising:
a light-providing unit generating light;
a display panel selectively displaying an image corresponding to a first driving mode or a second driving mode using light from the light-providing unit; and
a panel driving unit driving the display panel, the panel driving unit comprising:
a power controller outputting a first power controlling signal of a digital format, which corresponds to the first driving mode, and a second power controlling signal of a digital format, which corresponds to the second driving mode;
a D/A converter outputting a first power voltage of an analog format in response to the first power controlling signal and a second power voltage of an analog format in response to the second power controlling signal, wherein a in level of the second power voltage is smaller than a level of the first power voltage;
a data driver outputting a first data voltage to the display panel in response to the first power voltage, and a second data voltage to the display panel in response to the second power voltage; and
a gate controller driver outputting a first gate controlling signal to the display panel in response to the first power voltage, and a second gate controlling signal to the display panel in response to the second power voltage.

13. The display device of claim 12, wherein the display panel comprises a plurality of display lines, wherein the display panel displays the image through a first set of display lines in the first driving mode, and wherein the display panel displays the image through a second set of display lines in the second driving mode, wherein the second set of display lines is a subset of the first set of display lines.

14. The display device of claim 12, wherein the panel driving unit further comprises a mode selector outputting a mode selecting signal to the power controller in response to a mode controlling signal.

15. The display device of claim 14, wherein the mode selecting signal comprises a first mode selecting signal corresponding to the first driving mode, and a second mode selecting signal corresponding to the second driving mode.

16. The display device of claim 15, wherein the mode selector comprises a multiplexer (MUX) circuit that switches the mode controlling signal and outputs the first mode selecting signal and the second mode selecting signal to the power controller.

17. The display device of claim 16, wherein the panel driving unit further comprises an input interface receiving the mode controlling signal from an external device.

18. A method of driving a display device, the display device comprises a display panel including a plurality of gate lines and a plurality of data lines, the method comprising:
receiving a mode controlling signal;
selectively outputting, in response to the mode controlling signal, a first mode selecting signal to a first power supply corresponding to a first driving mode, and a second mode selecting signal to a second power supply corresponding to a second driving mode;
selectively outputting a first power voltage to a data driver and a gate controller in response to the first mode selecting signal and a second power voltage to the data driver and the gate controller in response to the second mode selecting signal, wherein the second power voltage is smaller than the first power in voltage;
selectively outputting a first data voltage to the display panel in response to the first power voltage, and a second data voltage to the display panel in response to the second power voltage; and
selectively outputting a first gate controlling signal to the display panel in response to the first power voltage, and a second gate controlling signal to the display panel in response to the second power voltage.

19. The method of claim 18, wherein a first power supply outputting the first power voltage and a second power supply outputting the second power voltage are separately formed.

20. The method of claim 19, wherein the display panel selectively displays an image through a first set of display lines in the first driving mode, and displays the image through a second set of display lines in the second driving mode, and wherein the second set of display lines is a subset of the first set of display lines.

21. A method of driving a display device that comprises a display panel including a plurality of gate lines and a plurality of data lines, the method comprising:
receiving a mode controlling signal;
selectively outputting, in response to the mode controlling signal, a first mode selecting signal corresponding to a first driving mode and a second mode selecting signal corresponding to a second driving mode to a power controller;
selectively outputting a first power controlling signal of a digital format to a D/A converter in response to the first mode selecting signal, and a second power controlling signal of a digital format to the D/A converter in response to the second mode selecting signal-selectively outputting a first power voltage of an analog format in response to the first power controlling signal, and a second power voltage of an analog format in response to the second power controlling signal wherein the level of the second power voltage is smaller than the level of the first power voltage;
selectively outputting a first data voltage to the display panel in response to the first power voltage, and a second data voltage to the display panel in response to the second power voltage; and
select very outputting a first gate controlling signal to the display panel in response to the first power voltage and a second gate controlling signal to the display panel in response to the second power voltage.

22. The method of claim 21, wherein the display panel selectively displays an image through a first set of display lines in the first driving mode and displays the image through a second set of display lines in the second driving modes and wherein the second set of display lines is a subset of the first set of display lines.
